(19) United States
(12) Patent Application Publication
(10) Pub. No.: US 2023/0274378 A1
(43) Pub. Date: Aug. 31, 2023

(54) SYSTEMS AND METHODS FOR IMPROVING COLLEGE AND GRADUATE ADMISSIONS PROFILE COMPETITIVENESS

(71) Applicant: Admit Analytics, Inc., Rockville, MD (US)

(72) Inventor: Eric B. Allen, Rockville, MD (US)

(21) Appl. No.: 17/682,915

(22) Filed: Feb. 28, 2022

(51) Int. Cl. G06Q 50/20; G06F 3/0482

(52) U.S. Cl. CPC G06Q 50/2053; G06F 3/0482

(57) ABSTRACT

Systems and methods for improving a candidate's admission competitiveness are contemplated. The candidate provides input responsive to prompts for academic criteria, experience criteria, and customized criteria, for example set by an institution. The inputs are valued and a score is assigned to each criteria category, and summed to a candidate score. Specific inputs are identified that can be modified to improve the candidate score. The specific inputs and modifications are provided to the candidate with a recommended action directed at realizing the modifications and improving the candidate score. Actual admissions outcomes or matriculant data can further be cross referenced and compared with candidate scores to re-weight calculation of the value of an input or criteria category and improve accuracy of candidate score and admission potential.

### FIELD OF THE INVENTION

The field of the invention is methods and systems related to admissions.

### BACKGROUND

The background description includes information that may be useful in understanding the present invention. It is not an admission that any of the information provided herein is prior art or relevant to the presently claimed invention, or that any publication specifically or implicitly referenced is prior art.

The college and graduate school application process is cumbersome and causes much anxiety and fear to applicants. The admissions process continues to get more competitive each year with top schools driving admissions rates well below 10%. To improve their chances of success, applicants spend hundreds of millions of dollars each year on tutoring, test preparation and admissions coaching. The first step for any applicant is to get a sense of where their admissions profile stands in the context of the general admissions pool and how that application compares to typical school matriculants. But, Applicants want to know more than just where they stand; they want to know what they can do to improve their admissions profile in view of their peers. Applicants also want to know where they stand in relation to desired schools. While efforts have been made to match applicants with institutions or predict acceptance of an applicant to a particular school, there is a lack of systems, tools, or methods to provide a standardized admissions score with customized feedback on how to optimize a candidate's admissions profile while providing relational guidance on schools.

Thus, there remains a need for systems, methods, and tools for determining an applicant's standing relative to a peer group or an institution, and providing actionable recommendations specific to an applicant for improving such standing.

### SUMMARY OF THE INVENTION

The inventive subject matter provides systems, methods, and tools for improving a user's candidacy, for example in admissions to an institution. An input regarding the user is received and includes information related to at least two criteria selected from an academic criteria, an experience criteria, or a customized (e.g., user customized, institution customized, etc.) criteria. A value is calculated representative of each criteria and summed to a user score. A subset of information is identified from the two criteria which the user can improve, such that improving the subset of information increases the user score. The subset of information is then provided to the user with a recommended action to improve the subset, and thus the user score.

Further systems, methods, and tools for improving an admission potential of a user are contemplated. An input regarding the user is received and includes information related to at least two criteria selected from an academic criteria, an experience criteria, or a customized criteria. A value is calculated representative of each criteria and summed to a user score. A user interest is received and used to identify at least one potential institution. A delta or difference between the user score and a threshold score or score range for the institution is then identified. A first subset of information from the two criteria is identified that the user can improve, such that improving the first subset of information reduces the delta. The first subset of information is provided to the user with a suggested step or action to improve the first subset, and thus the user score.

Systems, methods, and tools for improving a competitiveness of a user are further contemplated. An input regarding the user is received and includes information related to at least two criteria selected from an academic criteria, an experience criteria, or a customized criteria. A value is calculated representative of each criteria and summed to a user score. A user interest is received and used to identify at least one potential candidate in competition with the user related to the user interest. A delta between the user score and a score of the potential candidate is calculated. A first subset of information from the two criteria that the user can improve is identified, such that improving the first subset of information reduces the delta. The first subset of information is provided to the user with a recommended action to improve the first subset.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 depicts a report generated by the inventive subject matter.

FIGS. 2A-2D depict a sample report generated by the inventive subject matter.

FIG. 3 depicts a flow chart of the inventive subject matter.

FIG. 4 depicts another flow chart of the inventive subject matter.

FIG. 5 depicts a yet another flow chart of the inventive subject matter.

### DETAILED DESCRIPTION

One aspect of the inventive subject matter is the Admit.me Index (“AMI”). The Admit.me Index is a novel “admissions credit score” that leverages 10, 20, 30, or over 30 user inputs to provide an independent admissions score that provides the user with a sense of their admission profile strength. The score is preferably on a scale of 200-1000 and preferably adjusts automatically as data is compiled across other candidates and schools. There are multiple subsections that are weighed differently across degree types (intellectual horsepower, professional experience, quantitative skills, demonstrated leadership, extracurricular involvement, and x-factor). While the score may be used as a standalone measurement of profile strength, school data can further be leveraged to index the profile candidate score.

The Admit.me Index is the world's first holistic admissions profile score. It provides a quantitative assessment of an individual's profile based on more than 30 factors about an applicant's profile. Some of the aspects that make the Admit.me Index unique include: (1) it quantifies factors previously unquantified including, but not limited to, work experience (e.g., quality of work experience, roles, titles, brands, etc.), volunteer experience, demographic information, major, etc.; (2) the AMI is completely independent from candidate school choice; (3) the AMI “learns” from experience—it updates factors based on previous applicant AMI and admissions outcomes; (4) the AMI can adjust to user inputs by placing greater emphasis on certain factors when other factors are unavailable or not provided, thus providing a dynamic score based on user input.

The AMI user inputs include Email, First Name, Last Name, Undergraduate School 1-GPA, Undergraduate School 1-Institution, Undergraduate School 1-Grad Year, Undergraduate School 1-Major, Undergraduate School 1-Major Category, Graduate Degree, Graduate School 1-GPA, Graduate School 1-Institution, Graduate School 1-Degree Category, Undergrad-Work, Undergrad-Varsity Sport, Undergrad-ROTC, Semester Abroad, Gap Year, College Campus, Gap Year Reason, Gap Year Reason_Other, Certifications, Job Training, Supplemental Courses, Supplemental Courses_Quantity, Supplemental Courses_Grade, Taken Test, Test Final, Test Planned, Scheduled Test Date, Test Score (Actual), Test Score (Target), Test Score Used, Managed Projects, Managed People, Managed Budgets, Work Experience Gap, Quantitative Job, Relocated For Work, Internships, Gap Length, Founder, Dismissed, Employers, Promotional History, Current Job Industry, Current Job Function, Intended Job Industry, Intended Job Function, Extracurricular_Volunteering through work, Extracurricular_On-campus recruiting, Extracurricular_Working a side hustle or part-time gig, Extracurricular_Religious Institution, Extracurricular_Civic Organization, Extracurricular_Individuals in Need, Extracurricular_Children, Young Adults, College Students, Extracurricular_Non-Profit, Extracurricular_Animals, Extracurricular_Non-listed Volunteering, Extracurricular_Serving on a condo or co-op board, Extracurricular_Participating in alumni engagements, Extracurricular_Playing in a sports league, Extracurricular_Other, Extracurricular_Other_Specify, Extracurricular Leadership, Age at time of matriculation, Legal Sex, Citizenship Region, US Citizen, US Military, Non-US Military, Multiple Countries, First Generation, LGBTQIA+, Multiple Languages, Ethnicity, Matriculation Term, and Year Start School.

Further, schools have the option to include additional questions specific to the school, including Specialty, Program Types, a variety of school selection priorities, Desired Regions, Campus Environments_In a city, Campus Environments_Near a city, Campus Environments_Near water, Campus Environments_Near snow sports, Campus Environments_Near outdoor activities, Campus Environments Strong sports college, Campus Environments_Lots of campus greenery, Campus Environments_Warm weather, Campus Environments_Campus-feel, Campus Environments_College town, and Learning Environment.

The Admit.me Index algorithm and processes are broken down into several categories which are independently calculated and factored into an overall score between 200 and 1000, though other ranges are contemplated as the system is adaptable.

Academic strength (AS) is a category that assesses a candidate's demonstrated intellectual ability. Resources to gauge this factor include academic record and test scores, and can be balanced against obligations outside of academics. This is a critical section for most schools as they are attempting to assess the candidate's ability to handle the academic rigors of college or graduate school, for example.

For some schools, work experience is an important consideration for the application process. The Work Experience (WE) category assesses a candidate's strength of work experience, consistency of work experience, promotion history and quality of work.

For certain programs, a clear demonstration of quantitative skills is critical and is assessed by the Quantitative Skills (QS) category. For other programs, this is not a significant factor in evaluation and the Q(f) defined below is adjusted appropriately, for example reduced.

The Extracurricular Involvement (EI) category is generally a consideration for schools is assessed by how applicants have given back to the community, work and school in the past.

The Demonstrated Leadership (DL) category attempts to quantify a candidate's historical leadership, as educational institutions are always looking for leaders.

There are always other factors involved in an admissions decision that fall into another category, assessed by the X-Factor (XF). The X-Factor typically includes supply/demand issues like demographic, location, and certain special considerations that would make a candidate unique in some way.

The Over-Index (OI) is preferably not available to the user, and allows for over-indexing of one or more of the previously identified sections, if made allowable within a certain school Admit.me Index score.

Admit.me Index Factors are the numerical factors used to calculate the weighting of the categories in the context of the Admit.me Index. The following Factors can change based on a few considerations of the school or the user. Certain school types value different types of factors. For instance, most undergraduate colleges place a low value on Work Experience, whereas an MBA program would place a high value on Work Experience. Further, the less information the user enters within a given category, the greater the potential for variability of the section, which can result in reduced weighting of that category.

The system can also vary the factor weighting as the system learns more about the historical accuracy of a profile scoring, views user inputs and choices, and compares everything with actual matriculation data. This learning and re-weighting is preferably done automatically via machine learning or AI, but it can also be adjusted from time to time, for example by adding new factors or based on actual admissions statistics.

The Factor Definitions include: A(f): Academic strength factor; W(f): Work experience factor; Q(f): Quantitative skills factor; E(f): Extracurricular involvement factor; D(f): Demonstrated leadership factor; X(f): Extra factor; and O(f): Over-indexing factor. As mentioned previously, these factors vary based on the specific school algorithm, or by the algorithm for a specific school. Further, depending on the formula or school a max score or score limit may be instituted for a particular category. Those scores are designated as Section_NameMax in the following formula.

AMI FORMULA:A(f)*min(AS,ASMax)+W(f)*min(WE,WEMax)+Q(f)*min(QS, QSMax)+E(f)*min(EI,EIMax)+D(f)*min(DL,DLMax)+X(f)*min(XF,XFMax)+0(f)*min(OI,OIMax)

The AMI is scored between 200 and 1000 so any score that is less than or exceeds that range will be forced into the limiting score. The output of taking the AMI is an overall AMI score between 200 and 1000. In addition to the numerical output, there is a relational score gauge of where the candidate fits (e.g., red/yellow/green, etc) versus other candidates in relation with schools (i.e. top 10, top 25, top 50, top 100, top 250).

The AMI report is a document that provides multiple points of client assessment, namely 1. An AMI Score; 2. Profile Assessment by Category; 3. Key Factor Assessment; 4. Action Items; and 5. School Suggestion List. A candidate is provided an overall AMI score along with a visual (red/yellow/green meter) and text representation (School range declaration) of where the score fits compared to the overall applicant pool. Each category (e.g., intellectual horsepower, professional experience, quantitative skills, demonstrated leadership, extracurricular involvement, and x-factor) is outlined and assigned a particular sub-score within the AMI, and provided in the Profile Assessment by Category. For each category listed above, the Key Factor Assessment provides textual context on each key section impacting the AMI. For each category listed above, the AMI Report provides Action Items with textual suggestions on how each specific user can optimize their specific user profile within that particular category, highlighting weaknesses and areas for improvement specific to each user. The School Suggestion List provides a summary of schools the user has identified along with suggested schools based on identified interests and competitive profiles commensurate with user AMI score. In addition, the school suggestion list shows the median AMI score range for matriculated candidates and a general competitive likelihood of admission.

Another aspect of the inventive subject matter is profile feedback. Users of the Admit.me Index get profile feedback. The profile feedback provides overall profile feedback, category and subcategory feedback, key factor feedback, and specific recommendations the user can take to improve various parts of the applicant profile. If a candidate's score falls in a certain range, we provide actionable feedback on the candidate's profile. We provide specific, actionable feedback by category and subcategory within the application profile. For example, custom narratives and key factors are matched to a user's score or category score and provided to the user for consideration for improvement based on the components of their specific profile. In addition, summary recommendations about each candidate's profile are also provided. All of this feedback is provided on a customized basis and based on a candidate's specific inputs.

Another aspect of the inventive subject matter is a school suggestion algorithm. The algorithm uses factors including the AMI score and user inputs about school preferences (e.g., location, academic reputation, career placement, campus life, extracurricular involvement, etc.) to suggest schools that would be a good fit based on interests and profile strength. From these factors, the invention determines a program fit score and uses that score to inform suggested schools.

In further detail, school suggestions are based on a few key themes: user-expressed interests “User Interests”, Admit.me Index score “Score”, and comparative assessments “Comparisons”. In certain cases with limited information, a school list across a number of competitive levels is provided to gain insight into candidate interest, and further iterated based on additional user information. The algorithm uses a school selection method based on user interests, overall AMI score and comparative schools of interest. The weighting depends on the strength of information provided in the AMI and school selection process.

The algorithm takes user interests and aligns user interests with school fit. Each set of the following user interests is mapped to a specific school factor: Geographic location, Undergraduate information, Test scores, Academic background, Quantitative background, Work experience, Citizenship, Military affiliation, Demographic information, Desired industry, Desired function, Desired degree(s), Desired program types, and School criteria (curriculum, student/alumni engagement, campus setting, location, career outcomes, scholarships, brand recognition, diversity and inclusion).

The AMI takes the AMI score and compares the score to the average score for schools in the applicant's target area of academic focus. The algorithm makes a match based on overall AMI score compared to score ranges at a particular school. School AMI ranges are calculated based on publicly available admissions profile data as well as data provided about past and current student admission information.

School comparisons are calculated using relational data in the AMI database. School suggestions are based on schools where the applicant has demonstrated interest, schools where other applicants with similar scores have demonstrated interest, schools where other applicants with similar school choices have demonstrated interest, and schools that have similar competitive factors and AMI scores to schools the applicant has been suggested.

The new and inventive features of the inventive subject matter include independent profile evaluation. Many known methods provide a competitive assessment versus an external factor (generally a school). These tools compare a user profile to a school profile. AMI is a standalone, profile evaluation tool (i.e. assessment of a candidate profile independent of external factors). Within the Admit.me platform, we compare the independent AMI to competitive schools, but the AMI is a standalone product that provides a profile assessment with actionable advice.

Further, the AMI is adaptive. The Admit.me Index adjusts scoring weights based on user input. For example, we provide different weightings for different inputs of data that are unknown to mimic an assessment at the current time. As data is learned, the user can come back and get an updated score. For example, if the user doesn't know their test score, we put more weight on other academic factors like GPA.

Moreover, AMI is holistic. The inventive subject matter provides a more representative evaluation because we leverage quantitative and non-quantitative factors. We have quantified previously unquantified information like volunteer experience, leadership qualities, demographics, and quality of work experience.

AMI is also actionable. The system includes more than 10, 20, 30, 40, or 50 action items that we can be catered or provided to users as a result of their AMI score. Viewed from another perspective, the inventive subject matter provides fully automated, custom admissions advice.

Further, the AMI leverages machine learning. The algorithms learn based on historical data. As more or verified acceptance information is received, the weighting variables of the various inputs are rebalanced to make the profile scores more accurate. For instance, if the data shows that enough credit is not given for a particular factor, the algorithm can self-correct within a desired range. The algorithm can further be manually updated as we learn additional information, for example adding new categories or subcategories. However, in preferred embodiments the algorithm is self-maintained and improved, and requires no manual intervention or maintenance.

The inventive subject matter provides systems, methods, and tools for improving a user's candidacy, for example in admissions to an institution. An input regarding the user is received and includes information related to at least two criteria selected from an academic criteria, an experience criteria, or a customized (e.g., user customized, institution customized, etc.) criteria. A value is calculated representative of each criteria and summed to a user score. A subset of information is identified from the two criteria which the user can improve, such that improving the subset of information increases the user score. The subset of information is then provided to the user with a recommended action to improve the subset, and thus the user score.

In some embodiments the academic criteria includes at least two of a grade point average, a credential (e.g., academic degree, accreditation, certification, license, etc.), a school, or a test score, and can also include academic honors, membership in an academic society, academic publications.

The experience criteria typically includes at least two of a training history (e.g., qualification, certification, etc.), a job function (e.g., type of employer (government, fortune 500, family business, etc.) role, responsibility, company hierarchy, management, professional, volunteer, salary, etc.) or a job performance (e.g., commendation, industry award, promotion, bonus, length of tenure, termination, discipline, project outcome, success rate, team success, etc.).

The customized criteria can include at least one of a demographic, a location (e.g., user location, desired location, undesired location, etc.), or a social status (e.g., gender/identity, age, poverty level, citizenship, immigration status, etc.). In some embodiments, the customized criteria is defined by a third party, for example an academic institution, a potential employer, a government agency, a potential client, or a compliance committee. The input regarding the user can further include information related to at least one of a skill criteria (e.g., language proficiency, etc.), a leadership criteria (e.g., community organizing, mentoring, elected position, etc.) or an extracurricular criteria (e.g., charity, volunteering, clubs, hobbies, talents, etc.).

When the value of each criteria is calculated, a multiple can be used to increase or decrease the relative significance of one or more of the criteria. In some embodiments, the multiple and the related criteria are determined by a third party, for example an academic institution, potential employer, government agency, or potential client. Similarly, maximum or minimum value limits can be set or changed for one or more criteria, for example increasing the maximum value limit of a criteria based on the input regarding the user.

Preferably the user score quantifies the user's candidacy or suitability for an institution, employer, role, or position.

Further systems, methods, and tools for improving an admission potential of a user are contemplated. An input regarding the user is received and includes information related to at least two criteria selected from an academic criteria, an experience criteria, or a customized criteria. A value is calculated representative of each criteria and summed to a user score. A user interest is received and used to identify a potential institution. A delta or difference between the user score and a threshold score of the institution is then identified. A first subset of information from the two criteria is identified that the user can improve, such that improving the first subset of information reduces the delta. The first subset of information is provided to the user with a suggested step or action to improve the first subset, and thus the user score.

Typically the threshold score or score range is either set by the institution or is representative of a median score for admission to the institution, for example based on matriculant data. The score or score range can additionally or alternatively rely on publicly available class profile data or proprietary information provided by the institution. In some embodiments improving the subset of information reduces the delta to at least zero, and can even increase the user score to greater than the threshold score. The user interest can also include at least one of a location, a degree, a field of work, a job responsibility, personal preferences, academic interests, or a desired institution.

A discrepancy can also be identified between the user score and an actual admission outcome. In such cases, it is favorable that a multiplier be applied to at least a second subset of information from the criteria, such that a new user score is consistent with the actual admission outcome. This process is preferably repeated as further information regarding the user is received, or additional admissions data is received or verified.

Systems, methods, and tools for improving a competitiveness of a user are further contemplated. An input regarding the user is received and includes information related to at least two criteria selected from an academic criteria, an experience criteria, or a customized criteria. A value is calculated representative of each criteria and summed to a user score. A user interest (e.g., field of study, academic degree, academic institution, field of employment, job opportunity, etc.) is received and used to identify at least one potential candidate in competition with the user related to the user interest. A delta between the user score and a score of the potential candidate is calculated. A first subset of information from the two criteria that the user can improve is identified, such that improving the first subset of information reduces the delta. The first subset of information is provided to the user with a recommended action to improve the first subset.

A criteria of the potential candidate can further be compared with at least one related criteria of the user. In such cases, it is favorable to identify how the user can improve the related criteria or identify an alternative criteria the user can improve to increase the user score relative to the potential candidate.

A result of a competition between the user and an actual candidate having the score of the potential candidate can further be received or acquired. In such cases, it is useful to identify a discrepancy between the user score and the result. A multiplier can then be applied to at least a second subset of information from the at least two criteria such that a new user score is consistent with the result. Such feedback allows inventive methods and systems to self-tune or correct deviations between actual and predicted outcome.

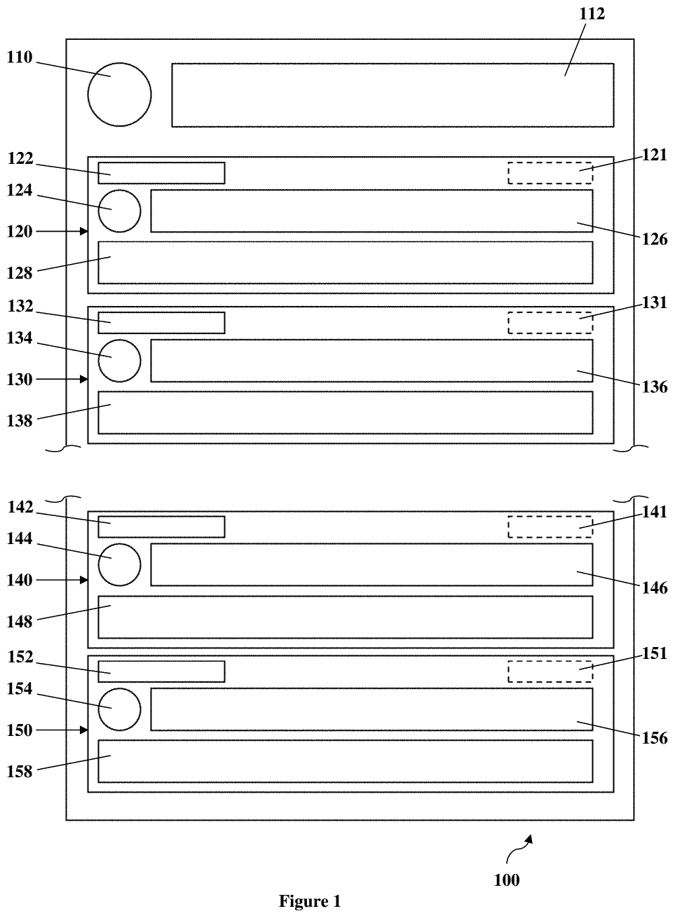

FIG. 1 depicts a model of AMI report 100 generated by the inventive subject matter. Report 100 is presented in a simplified manner to quickly and concisely present a user's AMI score 110, a synopsis 112 of the user's admissions profile, and detailed information to improve the score in sections 120, 130, 140, and 150. Each of sections 120, 130, 140, and 150 include a title (e.g., 122, 132, 142, 152), a toggle indicated whether the section needs improvement, or can be improved, or both (e.g., 121, 131, 141, 151), a section score (e.g., 124, 134, 144, 154), a section assessment (e.g., 126, 136, 146, 156) describing the user's strengths or weaknesses in each section, and key factors (e.g., 128, 138, 148, 158) for each section along with an explanation of the factor and the user's strengths and weaknesses for each factor. While report 100 includes 4 sections, it should be appreciated reports of the inventive subject matter include less or more than 4, for example 3 to 10, 2 to 15, or 1 to 20.

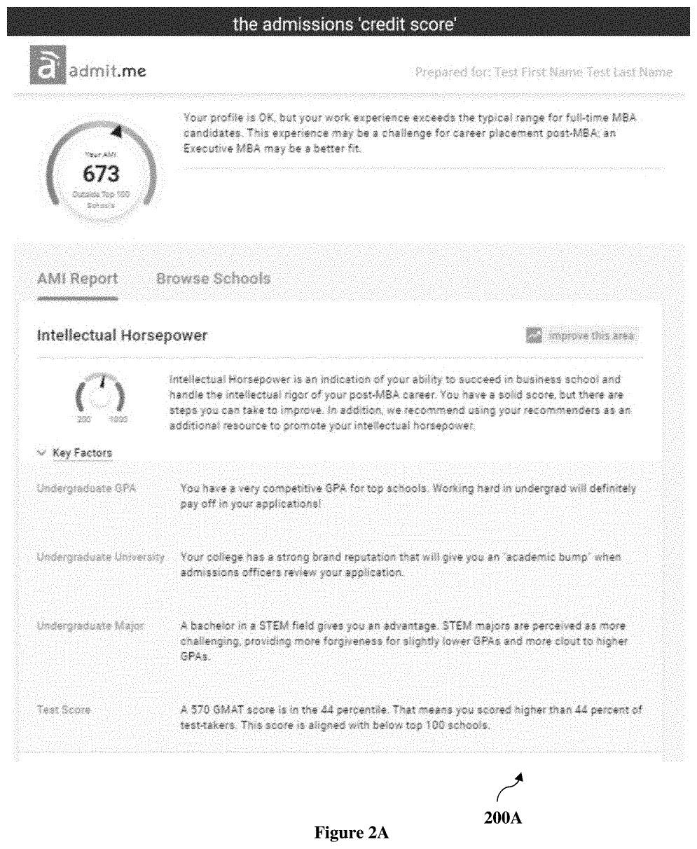

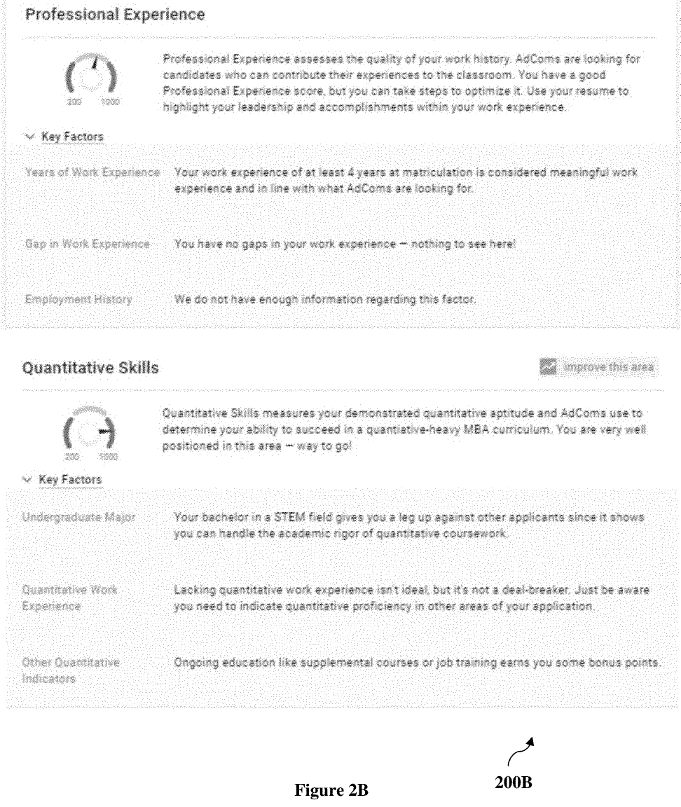

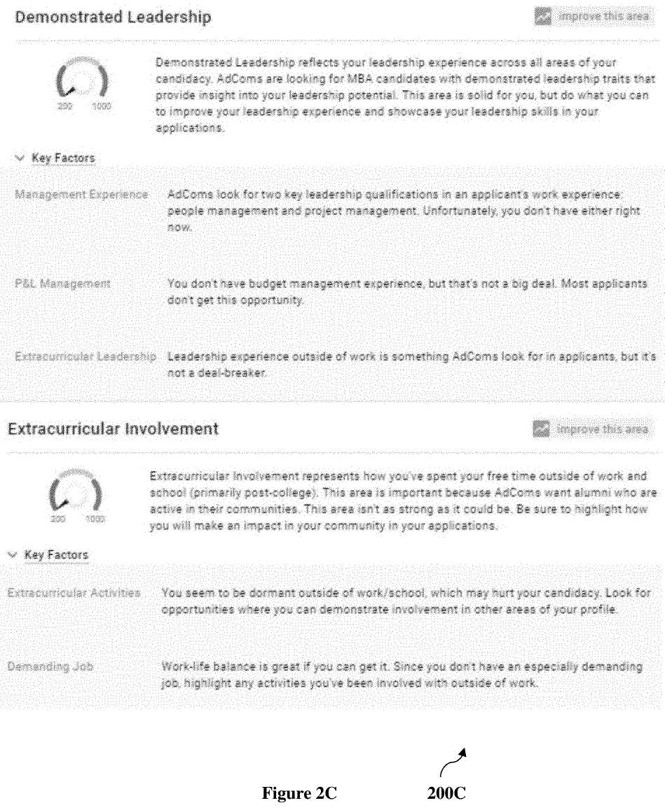

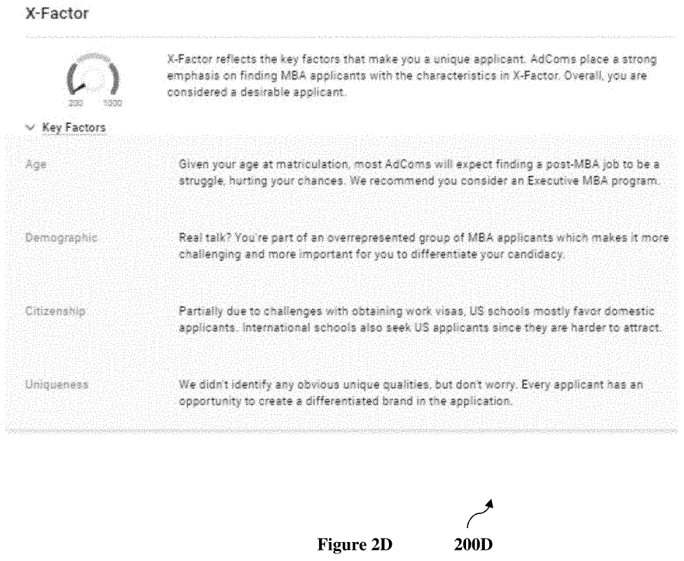

FIGS. 2A-2D depicts a portions 200A, 200B, 200C and 200D of an AMI report. Portion 200A includes the AMI score, synopsis, and a section of detailed information titled “Intellectual Horsepower.” Portion 200A indicates the “Intellectual Horsepower” section can or should be improved, and describes several key factors relevant to the user. Portion 200B depicts two sections, titled “Professional Experience,” which indicates no improvement is recommended or available, and “Quantitative Skills,” which indicates improvement can or should be made, as well as key factors for each section. Portion 200C depicts two sections, titled “Demonstrated Leadership” and “Extracurricular Involvement,” each of which indicates improvement can or should be made and describes relevant key factors. Portion 200D depicts a section titled “X-Factor,” which indicates no improvement is needed or available, as well as key factors for the section.

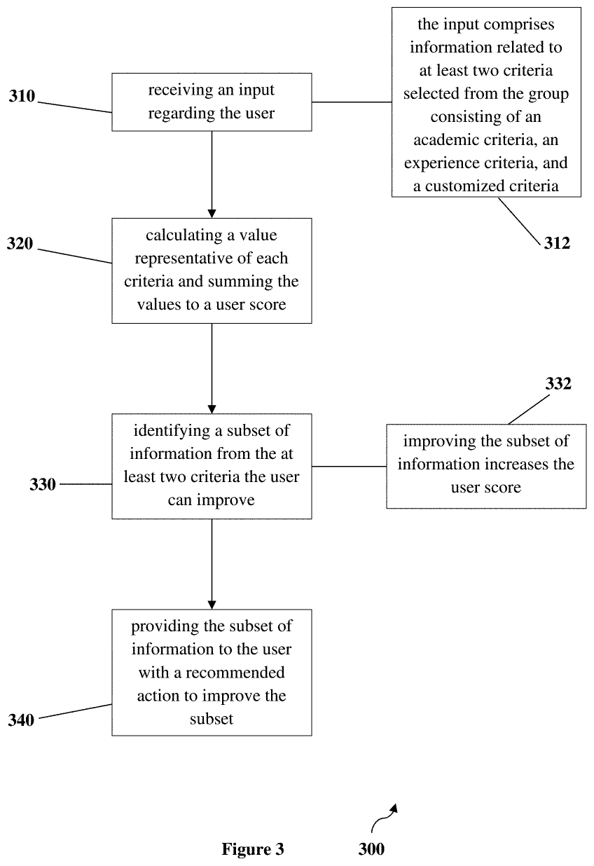

FIG. 3 depicts a flow chart of systems and methods of the inventive subject matter for improving a user's candidacy, for example as an applicant to a college or graduate school program.

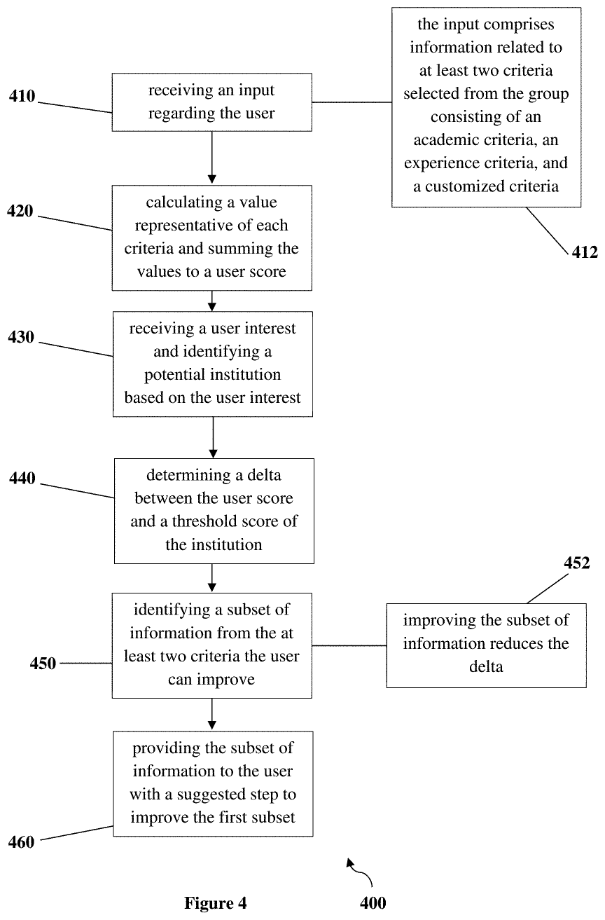

FIG. 4 depicts a flow chart of systems and methods of the inventive subject matter for improving an admission potential of a user.

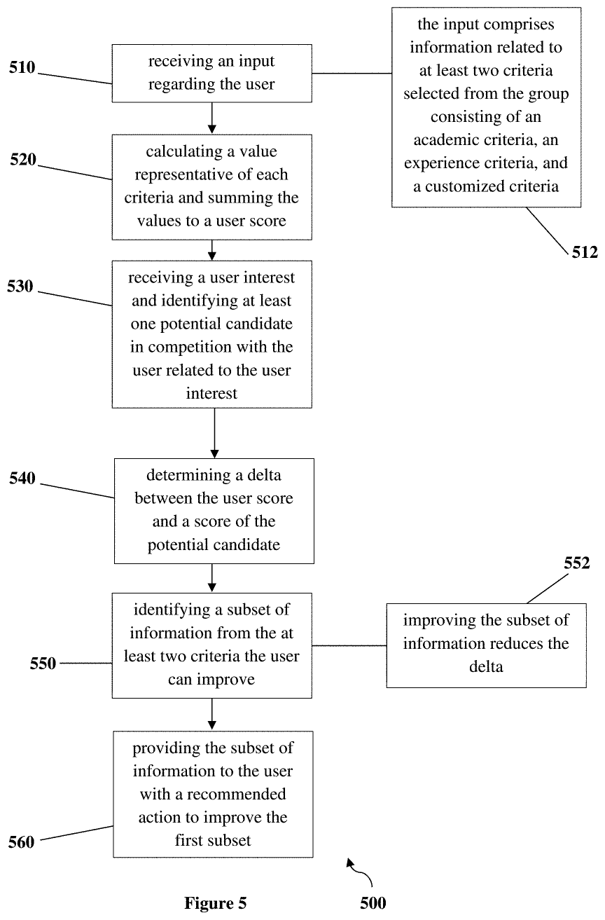

FIG. 5 depicts a flow chart of systems and methods of the inventive subject matter for improving competitive of a user among a pool of peers.

The following description includes information that may be useful in understanding the present invention. It is not an admission that any of the information provided herein is prior art, necessary, or relevant to the presently claimed invention, or that any publication specifically or implicitly referenced is prior art.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of improving a user's candidacy, comprising:
receiving an input regarding the user, wherein the input comprises information related to at least two criteria selected from the group consisting of an academic criteria, an experience criteria, and a customized criteria;
calculating a value representative of each criteria and summing the values to a user score;
identifying a subset of information from the at least two criteria the user can improve, wherein improving the subset of information increases the user score; and
providing the subset of information to the user with a recommended action to improve the subset.

2. The method of claim 1, wherein the academic criteria includes at least two of a grade point average, a degree, a school, and a test score.

3. The method of claim 1, wherein the experience criteria includes at least two of a training history, a job function, and a job performance.

4. The method of claim 1, wherein the customized criteria includes at least one of a demographic, a location, or a social status.

5. The method of claim 1, wherein the customized criteria is defined by a third party, optionally an academic institution.

6. The method of claim 1, wherein the input further comprises information related to at least one of a skill criteria, a leadership criteria, and an extracurricular criteria.

7. The method of claim 1, further comprising applying a multiple to the value of at least one criteria.

8. The method of claim 7, wherein the multiple and the at least one criteria are determined by a third party, optionally an academic institution.

9. The method of claim 1, wherein at least one criteria has a maximum value limit, and wherein the maximum value limit is increased based on the input regarding the user.

10. The method of claim 1, wherein the user score quantifies the user's candidacy.

11. A method of improving an admission potential of a user, comprising:
receiving an input regarding the user, wherein the input comprises information related to at least two criteria selected from the group consisting of an academic criteria, an experience criteria, and a customized criteria;
calculating a value representative of each criteria and summing the values to a user score;
receiving a user interest and identifying a potential institution based on the user interest;
determining a delta between the user score and a threshold score of the institution;
identifying a first subset of information from the at least two criteria the user can improve, wherein improving the first subset of information reduces the delta; and
providing the first subset of information to the user with a suggested step to improve the first subset.

12. The method of claim 11, wherein the threshold score is either set by the institution or representative of a median score for admission to the institution based on matriculant data.

13. The method of claim 11, wherein improving the subset of information reduces the delta to at least zero.

14. The method of claim 11, wherein improving the first subset of information makes the user score greater than the threshold score.

15. The method of claim 11, wherein the user interest includes at least one of a location, a degree, a field of work, a job responsibility, personal preferences, academic interests, or a desired institution.

16. The method of claim 11, further comprising the steps of:
identifying a discrepancy between the user score and an actual admission outcome; and
assigning a multiplier to at least a second subset of information from the at least two criteria such that a new user score is consistent with the actual admission outcome.

17. A method of improving a competitiveness of a user, comprising:
receiving an input regarding the user, wherein the input comprises information related to at least two criteria selected from the group consisting of an academic criteria, an experience criteria, and a customized criteria;
calculating a value representative of each criteria and summing the values to a user score;
receiving a user interest and identifying at least one potential candidate in competition with the user related to the user interest;
determining a delta between the user score and a score of the potential candidate;
identifying a first subset of information from the at least two criteria the user can improve, wherein improving the first subset of information reduces the delta; and
providing the first subset of information to the user with a recommended action to improve the first subset.

18. The method of claim 17, wherein the user interest is one of a field of study, an academic degree, an academic institution, a field of employment, or a job opportunity.

19. The method of claim 17, further comprising comparing a criteria of the potential candidate with at least one related criteria of the user and (i) identifying how the user can improve the related criteria or (ii) identifying an alternative criteria the user can improve to increase the user score.

20. The method of claim 17, further comprising the steps of:
receiving a result of a competition between the user and an actual candidate having the score of the potential candidate;
identifying a discrepancy between the user score and the result; and
assigning a multiplier to at least a second subset of information from the at least two criteria such that a new user score is consistent with the result.
